(19) United States
(12) Patent Application Publication
(10) Pub. No.: US 2007/0143161 A1
(43) Pub. Date: Jun. 21, 2007

(54) Application independent rendering of scorecard metrics

(75) Inventors: Ian Tien, Seattle, WA (US); Catalin I. Tomai, Bellevue, WA (US); Chen-I Lim, Bellevue, WA (US); Corey Hulen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/313,324

(22) Filed: Dec. 21, 2005

(51) Int. Cl. G06F 9/44

(52) U.S. Cl. 705/7

(57) ABSTRACT

Application independent rendering of scorecard metrics is provided. A hierarchy for scorecard metrics, such as KPI's, KPI groups, and objectives, is determined and data associated with each scorecard metric is retrieved based on the hierarchy. Scorecard calculation is performed based on the retrieved data and the hierarchy. A scorecard representation may then be generated based on the calculation and transformed into a format such that application independent reports can be generated based on the scorecard representation. The transform may include generating a document using Report Definition Language (RDL). The RDL document may then be forwarded to an application for report generation.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Scorecards are used to provide detailed and summary analysis of KPI's and aggregated KPI's such as KPI groups, objectives, and the like. Scorecard calculations are typically specific to a defined hierarchy of the above mentioned elements, selected targets, and status indicator schemes. Business logic applications that generate, author, and analyze scorecards are typically enterprise applications with multiple users (subscribers), designers, and administrators. It is not uncommon, for organizations to provide their raw performance data to a third party and receive scorecard representations, analysis results, and similar reports.

### SUMMARY

For application independent rendering of scorecard metrics, a hierarchy for the metrics associated with a scorecard is determined and data associated with each scorecard metric is retrieved based on the hierarchy. The retrieved data and the hierarchy are used for scorecard calculation resulting in a scorecard representation. The scorecard representation may be transformed into a standardized format such that application independent reports can be generated based on the calculation results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a business logic application for application independent rendering of scorecard metrics may be executed;

FIGS. 2A and 2B illustrate a system and an action diagram for example embodiments of application independent rendering of scorecard metrics;

FIG. 3 illustrates an example scorecard architecture according to embodiments;

FIG. 4 illustrates a screenshot of an example scorecard;

FIG. 5 illustrates boundary selection in a scorecard application using text boxes and sliders, and relationship of boundary sliders with indicator ranges in boundary preview;

FIG. 6 illustrates an example system for scorecard report rendering; and

FIG. 7 illustrates a logic flow diagram for a process of application independent rendering of scorecard metrics.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

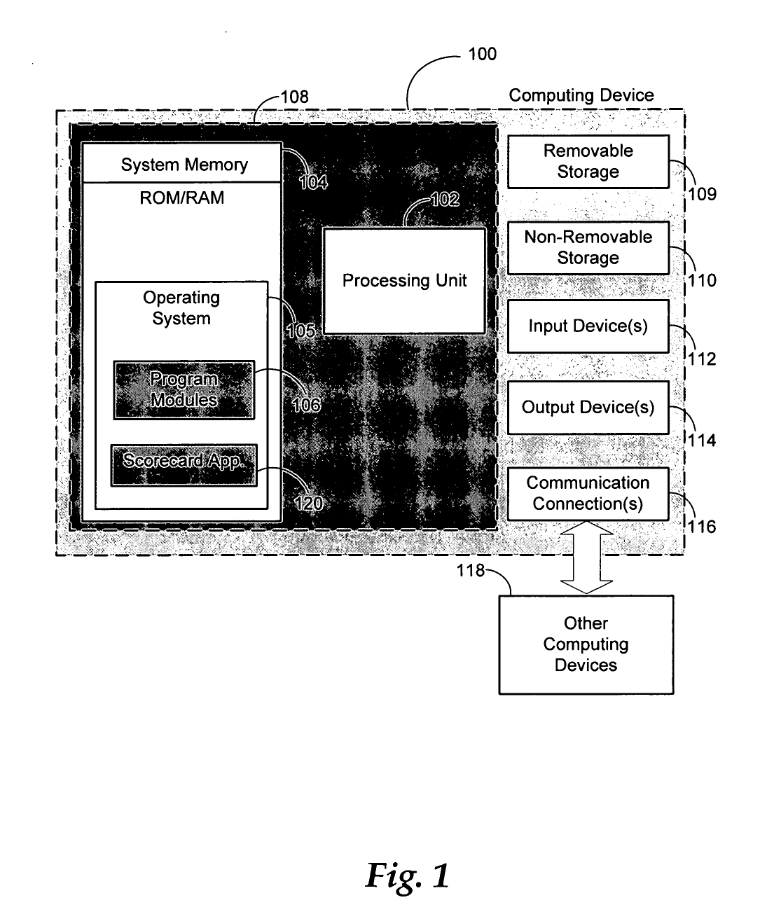

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, scorecard application 120 may also be executed within operating system 105. Scorecard application 120 may include a scorecard application or any similar application to manage business evaluation methods. Scorecard application 120 may retrieve data associated with one or more scorecards, perform scorecard calculations, and render scorecard presentation(s) or provide scorecard data for other types of reports.

To perform the actions described above, scorecard application 120 may include and/or interact with other computing devices, applications, and application interfaces (APIs) residing in other applications.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

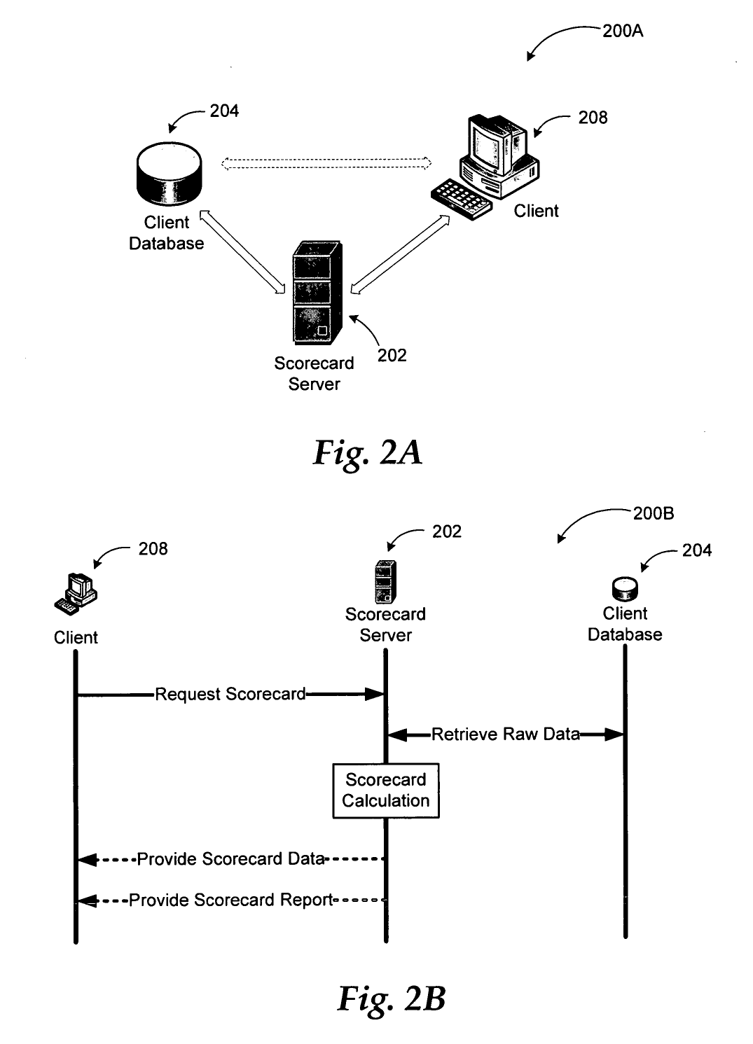

FIGS. 2A and 2B illustrate a system and an action diagram for example embodiments of application independent rendering of scorecard metrics. Referring to FIG. 2A, a basic system for scorecard implementation is illustrated. System 200A includes scorecard server 202, client device 206, and client database 204. While the three elements of system 200A are shown communicating directly with each other, scorecard server 202 may interact with database 204 and client 206 over a network (not shown) for performing scorecard calculations and rendering reports. The network may be a secure network such as an enterprise network, or an unsecure network such as a wireless open network. Such a network is intended to provide communication between the nodes described above. By way of example, and not limitation, the network may include wired media such as a wired network or direct-wired connection, and wireless media such as acoustic, RF, infrared and other wireless media.

System 200A may also comprise any topology of servers, clients, Internet service providers, and communication media. Also, system 200 may have a static or dynamic topology. A business logic application may be run centrally on server 202 or in a distributed manner over several servers and/or client devices. Server 202 may include implementation of a number of information systems such as performance measures, business scorecards, and exception reporting. A number of organization-specific applications including, but not limited to, financial reporting, analysis, booking, marketing analysis, customer service, and manufacturing planning applications may also be configured, deployed, and shared in system 200.

Client database 204 is an example of a number of data sources that may provide input to server 202. Additional data sources may include SQL servers, databases, non multi-dimensional data sources such as text files or EXCEL® sheets, multi-dimensional data source such as data cubes, and the like.

In a typical application, subscribers may interact with server 202 running the business logic application from client device 206 and provide information as to what kind of scorecard calculation, on which data, and what type of reporting are desired. Based on the provided information, server 202 may determine a hierarchy of a scorecard and retrieve data associated with the scorecard metrics from client database 204. Server 202 may then perform the scorecard calculation and provide either a prepared report (e.g. scorecard representation) or scorecard data to be used in a client prepared report to client device 206.

The actions described above are illustrated in action diagram 200B of FIG. 2B between client device 206, scorecard server 202, and client database 204.

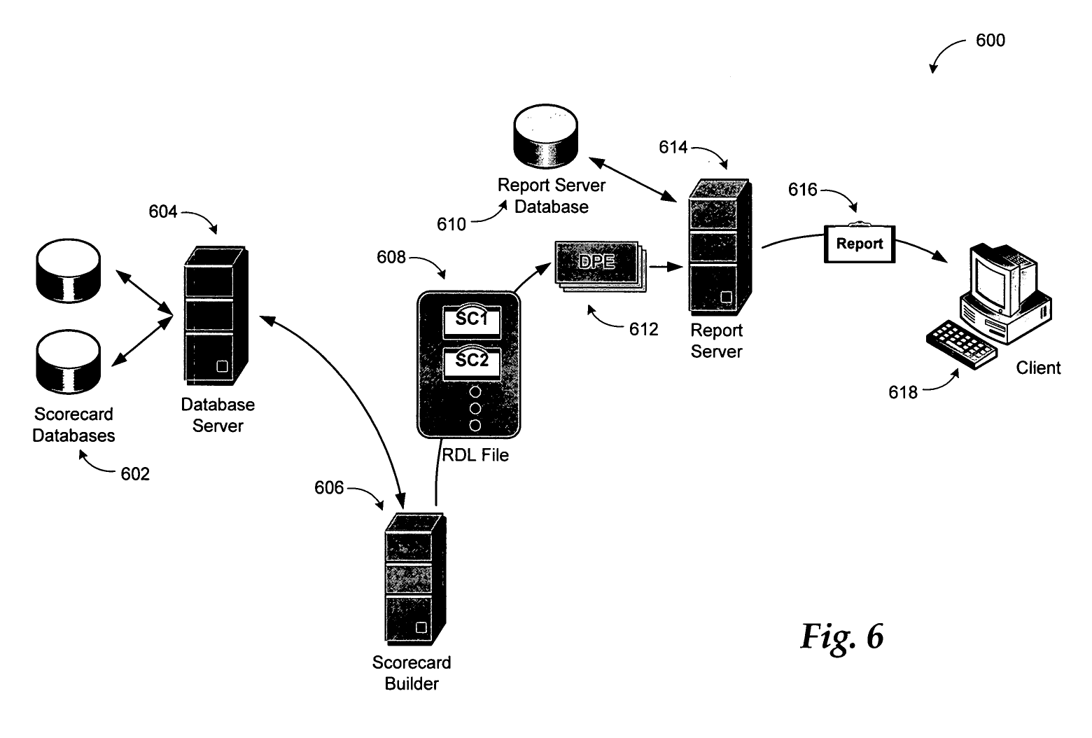

It should be noted that system 200A and action diagram 200B are simplified diagrams for illustration purposes only. Many other configurations of computing devices, applications, data sources, data distribution and analysis systems may be employed to implement a business logic application with application independent rendering of scorecard metrics. In fact, a more detailed example embodiment is shown in FIG. 6 below.

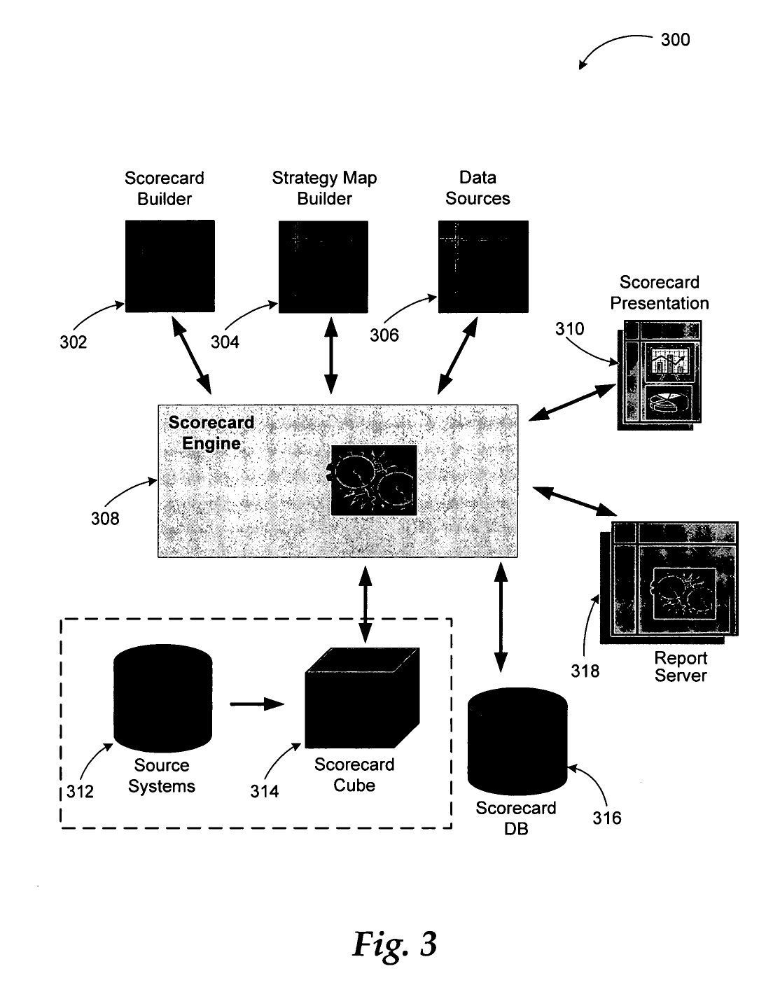

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application that is arranged to evaluate performance metrics. Scorecard engine 308 may be loaded into a server, executed over a distributed network, executed in a client device, and the like.

Data for evaluating various measures may be provided by a data source. The data source may include source systems 312, which provide data to a scorecard cube 314. Source systems 312 may include multi-dimensional databases such as an Online Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)—accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like.

Furthermore, scorecard architecture 300 may include report server 318. Report server 318 may receive scorecard calculation results such as a scorecard representation in a standardized format that includes layout and property information for the scorecard elements and generate its own reports using an application such as those described previously as an example.

In one embodiment, the transform of the scorecard representation may include generating a document using Report Definition Language (RDL). The RDL document may then be forwarded to an application such as a charting application, a spreadsheet application, a word processing application, and the like. The RDL document may include layout information for the scorecard representation, data for each calculated scorecard metric, and/or property information for each scorecard representation element.

In another embodiment, the scorecard representation may be filtered based on a subscriber permission status.

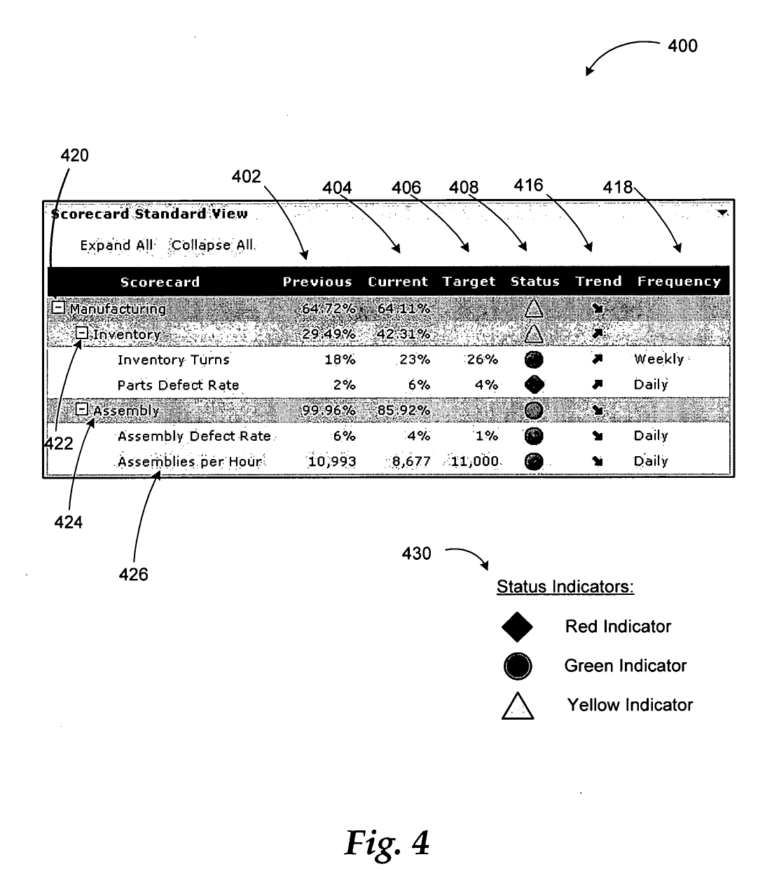

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

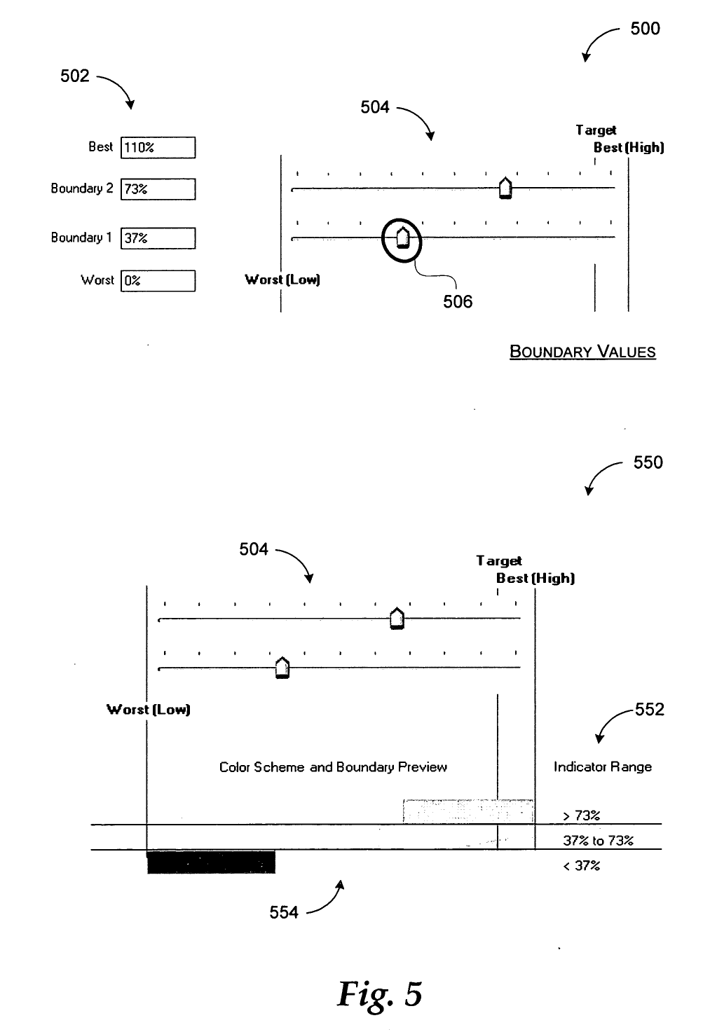

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands as described below in conjunction with FIG. 5.

Column 416 includes trend type arrows as explained above under KPI attributes. Column 418 shows another KPI attribute, frequency.

FIG. 5 illustrates boundary selection in a scorecard application using text boxes and sliders, and relationship of boundary sliders with indicator ranges in boundary preview.

The user is provided with an option to use sliders to manipulate the boundary values or to manually enter them. In some embodiments, there may be more than one lower and upper boundary values (e.g. Closer To Target Is Better). The controls for entering Boundary Values are shown in user interface 500. When a user drags the slider (e.g. slider 506) in slider region 504 of the user interface, the values in the text boxes of text box region 502 are changed to reflect the current position of the slider. Conversely, when a boundary is manually entered into the text box the sliders are automatically adjusted to the correct position to reflect the change.

The number of sliders displayed is equal to the number of boundaries for the selected Indicator. In the case when there is more than one boundary value, the sliders restrict the user from overlapping boundaries. For example, if Boundary 1's slider is dragged to the right past Boundary 2's slider, Boundary 2's slider is automatically updated to be at the same position as Boundary 1's slider. This update is also reflected in the Boundary 2's text box. Following the same behavior of restricting overlapping with the sliders, if a boundary value is entered past another in the text box, the overlapped boundary value is changed.

The sliders and text boxes are not the only objects whose behavior is linked together. When the slider is moved, the changes are also reflected in the Boundary Preview and the Indicator Range regions as shown in user interface 550. The boundaries may be depicted by a change in color and level in Boundary Preview chart 554. As shown in user interface 550, the boundaries are depicted directly below slider region 504.

When a user drags a slider, the corresponding boundary is moved to reflect the change in slider position. The values under Indicator Range 552 are also updated to reflect the boundary changes and depict the correct values for the range. For example, in user interface 550 the lighter colored bar (indicating acceptable but potentially problem status) grows and the darker colored bar (indicating acceptable status) gets shorter, if the upper boundary is moved to the right to 80%. The 73% value in the Indicator Ranges is also changed to 80%.

FIG. 6 illustrates example system 600 for scorecard report rendering. System 600 includes scorecard databases 602, database server 604, scorecard builder 606, report server database 610, DPE API 612, report server 614, and client device 618. It should be noted many elements of system 600 may be implemented as hardware, software, or combinations of the two. For example, scorecard builder 606 may be dedicated server, or an application running on an enterprise server. Report server 614 may be a server on a client system, or an application running the same enterprise server as scorecard builder 606.

In an operation mode, scorecard builder 606 may receive information specifying scorecard elements (metrics) and their hierarchy from a subscriber. Scorecard builder 606 then requests data associated with the selected metrics from database server 604. Database server 604 manages scorecard databases 602, which may be data sources that belong to a client. The requested data is retrieved and provided to scorecard builder 606, which performs the scorecard calculation determining scores and status indicators based on the retrieved data and the specified hierarchy. The scores may be calculated based on a multi-dimensional data source, a user input, or an analytical data model.

Results of the scorecard calculation are typically provided in a scorecard representation (e.g. scorecard matrix or list). Where the client desires to have one or more application specific reports, the results are provided to report server 614 in an application independent format (RDL file 608). For that purpose, Report Definition Language (RDL) may be utilized. A report definition contains data retrieval and layout information for a report. RDL is an XML representation of this report definition. RDL is an open schema that can be extended with additional attributes and elements.

As mentioned, RDL is a set of instructions that describe layout and query information for a report. RDL is composed of XML elements that conform to an XML grammar. RDL describes the XML elements, which encompass possible variations that a report can assume. Custom functions for controlling report item values, styles, and formatting can be added by accessing code assemblies from within report definition files. Moreover, RDL can be generated programmatically.

Data Processing Extension (DPE) API 612 may be used as a bridge between report server 614 and scorecard builder 606 acting as data source for the report server. DPE 612 enables report server 614 to connect to a data source (e.g. scorecard builder 606) and retrieve data. DPE 612 also may serve as a bridge between a data source and a dataset.

Report server 614 receives content, layout information, and property information associated with the scorecard metrics from scorecard builder 606. Report server 614 may further receive data from report server database 610 associated with generating the report(s) based on the scorecard calculations. Generated report 616 is then passed on to a subscriber via client device 618.

While specific schemas, protocols, and languages are described in the above example, the invention is not so limited. Providing application independent rendering of scorecard reports may be implemented using other system configurations, schemas, protocols, file types, languages, and the like, using the principles described herein.

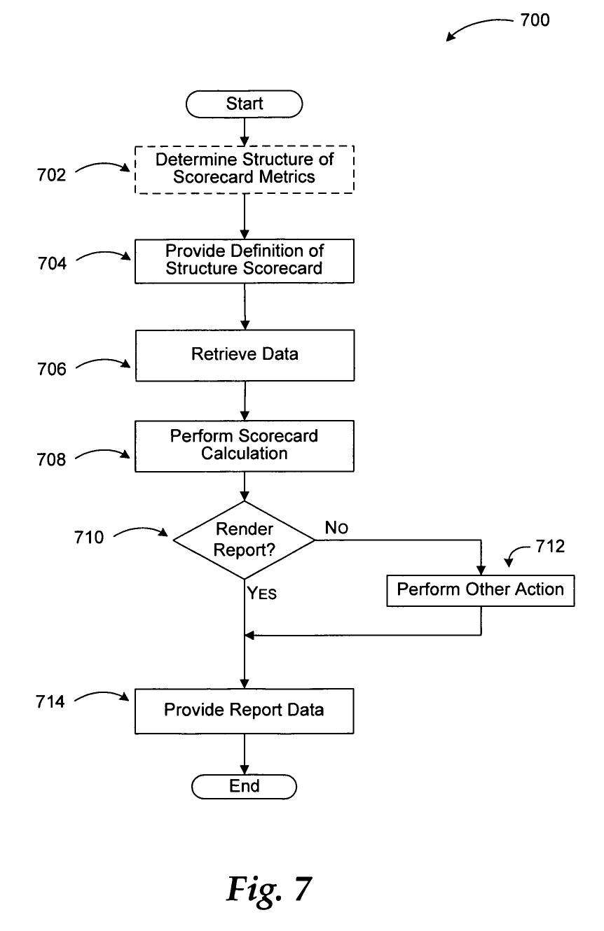

FIG. 7 illustrates a logic flow diagram for a process of application independent rendering of scorecard metrics.

Process 700 begins at optional operation 702, where a structure of scorecard metrics is determined. As described previously, a scorecard is based on a specific hierarchy of its elements, and scores and status indicators are determined based on this hierarchy. The scorecard metrics may include at least one of a Key Performance Indicator (KPI), a KPI group, or an objective. As described before, the scorecard calculation may include determining a KPI score for each KPI reporting to a selected scorecard metric based on a comparison of an actual value and an associated target value of the KPI, and determining a rolled-up score of all KPI's reporting to the selected scorecard metric based on a weighted aggregation of the KPI scores. Processing moves from optional operation 702 to operation 704.

At operation 704, a definition of the scorecard structure is provided to a scorecard server, which determines data to be retrieved from one or more data sources to perform the scorecard calculation(s). Processing advances from operation 704 to operation 706.

At operation 706, data associated with the scorecard structure is retrieved from the data source(s). The data may include content for scorecard metrics, as well as metadata that indicates layout and property information for the scorecard elements. Processing proceeds from operation 706 to operation 708.

At operation 708, the scorecard calculation is performed. Scorecard calculation includes determination of scores for individual scorecard metrics, rolling up of the individual scores to higher level metrics up to the scorecard level, and assignment of status indicators based on the scores and roll-ups. Processing moves from operation 708 to decision operation 710.

At decision operation 710, a determination is made whether a report is to be rendered. A report based on the scorecard calculation may be rendered by the scorecard server itself in form of a scorecard representation or in any other format by another application that receives the report data. If a report is to be rendered, processing advances to operation 714. If the determination is negative, processing moves to operation 712, where the scorecard server performs other actions, such as analyzing the results, issuing alerts based on the results, and the like. Processing advances from operation 712 also to operation 714.

At operation 714, the report data is provided in a format that enables application independent rendering of the scorecard results. As described before, reports based on scorecard calculation may include print documents (e.g. PDF®, postscript files), spreadsheet documents (Excel® files), web publishing files (HTML), and the like. The rendered report data may be used as a data source in providing the report. The rendered report data may also be forwarded to a print application, a web publishing application, an electronic mail application, a charting application, a spreadsheet application, or a word processing application.

To allow easy consumption of the results data by a variety of applications in generating reports, report data may be transformed into a standardized format (RDL) that includes content, layout data, and property information, and forwarded to a report server for publishing. After operation 714, processing moves to a calling process for further actions.

The operations included in process 700 are for illustration purposes. Rendering scorecard metrics in an application independent manner may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for application independent rendering of scorecard metrics, comprising:
providing a definition for a logic structure for data associated with scorecard metrics;
retrieving the data based on the logic structure;
performing a scorecard calculation using the data and the logic structure; and
rendering the scorecard metrics based on the calculation such that an application independent report can be prepared.

2. The computer-implemented method of claim 1, further comprising determining the logic structure for the data based on one of: a subscriber input, a predetermined set of rules, a scorecard configuration, and a subscriber credential.

3. The computer-implemented method of claim 1, wherein the logic structure includes a column definition and a data type definition.

4. The computer-implemented method of claim 1, further comprising using the rendered scorecard metrics as a data source in providing the report.

5. The computer-implemented method of claim 1, wherein the data is retrieved from a plurality of data sources, and wherein the data is multidimensional.

6. The computer-implemented method of claim 1, further comprising forwarding the rendered scorecard metrics to at least one of: a print application, a web publishing application, an electronic mail application, a charting application, a spreadsheet application, and a word processing application.

7. The computer-implemented method of claim 6, wherein the data is forwarded in form of an extensible Markup Language (XML) file.

8. The computer-implemented method of claim 6, wherein the data includes at least one of: content and property information associated with the scorecard metrics.

9. The computer-implemented method of claim 8, wherein the property information designates the content as one of: a number, a string, and a graphic symbol.

10. The computer-implemented method of claim 1, wherein the logic structure includes metadata associated with the scorecard calculation.

11. The computer-implemented method of claim 1, wherein the scorecard metrics includes at least one of: a Key Performance Indicator (KPI), a KPI group, and an objective.

12. The computer-readable medium of claim 11, wherein the scorecard calculation includes determining a KPI score for each KPI reporting to a selected scorecard metric based on a comparison of an actual value and an associated target value of the KPI, and determining a rolled-up score of all KPI's reporting to the selected scorecard metric based on a weighted aggregation of the KPI scores.

13. A computer-readable medium having computer instructions for application independent rendering of a scorecard report, the instructions comprising:
determining a hierarchy for scorecard metrics;
retrieving data associated with each scorecard metric based on the hierarchy;
performing a scorecard calculation based on the retrieved data and the hierarchy;
generating a scorecard representation based on the calculation; and
transforming the scorecard representation into a format such that application independent reports can be generated based on the scorecard representation.

14. The computer-readable medium of claim 13, wherein transforming the scorecard representation includes generating a document using Report Definition Language (RDL).

15. The computer-readable medium of claim 14, further comprising forwarding the RDL document to an application.

16. The computer-readable medium of claim 14, wherein the RDL document includes at least one of: layout information for the scorecard representation, data for each calculated scorecard metric, and property information for each scorecard representation element.

17. The computer-readable medium of claim 13, wherein the scorecard representation is filtered based on a subscriber permission status.

18. A system for providing application independent scorecard reports, the system comprising:
a scorecard server configured to:
determine a hierarchy for scorecard metrics;
retrieve data associated with each scorecard metric based on the hierarchy;
perform a scorecard calculation based on the retrieved data and the hierarchy;
generate a scorecard representation based on the calculation; and
transform the scorecard representation into an RDL document:
a report server configured to:
receive the RDL document from the scorecard server; and
generate a scorecard report based on a subscriber selected application and at least one of: layout information for the scorecard representation, data for each calculated scorecard metric, and property information for each scorecard representation element included in the RDL document.

19. The system of claim 18, further comprising a database server configured to retrieve data associated with the scorecard metrics from at least one database, and provide the data to the scorecard server.

20. The system of claim 18, wherein the RDL document is provided to the report server employing a Data Processing Extension (DPE) Application Programming Interface (API).
